(19) United States
(12) Patent Application Publication
(10) Pub. No.: US 2025/0240811 A1
(43) Pub. Date: Jul. 24, 2025

(54) METHOD AND DEVICE FOR SCHEDULING IN WIRELESS COMMUNICATION SYSTEM

(71) Applicants: Samsung Electronics Co., Ltd., Suwon-si (KR); KOREA ADVANCED INSTITUTE OF SCIENCE AND TECHNOLOGY, Daejeon (KR)

(72) Inventors: Sanghyun LEE, Suwon-si (JP); Jaehong KIM, Daejeon (KR); Dongsu HAN, Daejeon (KR); Sangeon KIM, Suwon-si (KR); Seunghyun MIN, Suwon-si (KR); Yunheon LEE, Daejeon (KR); Hwijoon LIM, Daejeon (KR)

(21) Appl. No.: 19/175,802

(22) Filed: Apr. 10, 2025

Related U.S. Application Data
(63) Continuation of application No. PCT/KR2023/014435, filed on Sep. 21, 2023.

(30) Foreign Application Priority Data
Oct. 14, 2022 (KR) 10-2022-0132524
Oct. 25, 2022 (KR) 10-2022-0138553

(51) Int. Cl. H04W 72/566; H04L 47/62; H04L 47/6275; H04W 28/02; H04W 72/1263

(52) U.S. Cl. CPC H04W 72/569; H04L 47/622; H04L 47/6275; H04W 28/0236; H04W 72/1263

(57) ABSTRACT

A method performed by a base station in a wireless communication system may comprise: determining the priority of flows to be transmitted to at least one user; based on a new flow coming in, an intra-user flow scheduler determines whether the flow size is smaller than a specified threshold and updates the priority; and allocating the flow to a queue on the basis of the updated priority.

### CROSS-REFERENCE TO RELATED APPLICATIONS

This application is a continuation of International Application No. PCT/KR2023/014435 designating the United States, filed on Sep. 21, 2023, in the Korean Intellectual Property Receiving Office and claiming priority to Korean Patent Application Nos. 10-2022-0132524, filed on Oct. 14, 2022, and 10-2022-0138553, filed on Oct. 25, 2022, in the Korean Intellectual Property Office, the disclosures of each of which are incorporated by reference herein in their entireties.

### BACKGROUND

### Field

The disclosure relates to a wireless communication system and, for example, to a method and a device for scheduling in a wireless communication system.

### Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

Embodiments of the disclosure provide a method and a device for scheduling transmission of low-latency traffic in a wireless communication system.

According to various example embodiments of the disclosure, a method performed by a base station in a wireless communication system may include: determining priorities of flows to be transmitted to one user; based on a new flow coming in, determining, by an intra-user flow scheduler, whether a size of the flow is less than a specified threshold value and updating the priorities; and allocating the flow to a queue, based on the updated priorities.

According to various example embodiments of the disclosure, a device of a base station in a wireless communication system may include: a transceiver and at least one processor, comprising processing circuitry, wherein at least one processor, individually and/or collectively, is configured to: determine priorities of flows to be transmitted to one user; based on a new flow coming in, determine, by an intra-user flow scheduler, whether a size of the flow is less than a specified threshold value, and update the priorities; and allocate the flow to a queue, based on the updated priorities.

According to various example embodiments of the disclosure, a method performed by a base station in a wireless communication system may include: receiving, by an inter-user flow scheduler, information on packets scheduled in respective queues allocated to multiple terminals and on a priority indicating a scheduling order of the packets; selecting at least one user having a per-resource block (RB) metric similar to a per-RB metric configured by the inter-user flow scheduler and the priority; and allocating the packets to the selected at least one user.

According to various example embodiments of the disclosure, a device of a base station in a wireless communication system may include: a transceiver and at least one processor, comprising processing circuitry, wherein at least one processor, individually and/or collectively, is configured to: receive, by an inter-user flow scheduler, information on packets scheduled in respective queues allocated to multiple terminals and on a priority indicating a scheduling order of the packets; select at least one user having a per-resource block (RB) metric similar to a per-RB metric configured by the inter-user flow scheduler and the priority; and allocate the packets to the selected at least one user.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example of a radio resource region in a wireless communication system according to various embodiments;

FIG. 2 is a diagram illustrating an example scheduling operation of a base station according to various embodiments;

FIG. 3 is a graph illustrating example user distribution versus a normalized per-RB metric according to various embodiments;

FIG. 4 includes graphs illustrating CDF results of spectral efficiency, fairness index, and FCT distribution of schedulers according to various embodiments;

FIG. 5 is a block diagram illustrating an example network structure in a wireless communication system according to various embodiments;

FIG. 6 is a flowchart illustrating an example operation of a base station according to various embodiments;

FIG. 7 is a flowchart illustrating an example operation of a base station according to various embodiments;

FIG. 8 is a table illustrating a result of a scheduling operation of a base station according to various embodiments;

FIG. 9 is a block diagram illustrating an example configuration of a base station according to various embodiments; and

FIG. 10 is a block diagram illustrating an example configuration of a UE according to various embodiments.

With regard to the description of the drawings, the same or like reference signs may be used to designate the same or like elements.

### DETAILED DESCRIPTION

Various example embodiments of the present disclosure are now described in greater detail with reference to the drawings, wherein like reference numerals are used to refer to like elements throughout. In the following description, for purposes of explanation, numerous specific details are set forth. It may be apparent, however, that such aspect(s) may be practiced without these specific details.

The terms used in the disclosure are used merely to describe various embodiments, and are not intended to limit the scope of various embodiments. A singular expression may include a plural expression unless they are definitely different in a context. The terms used herein, including technical and scientific terms, may have the same meaning as those commonly understood by a person skilled in the art to which the disclosure pertains. Such terms as those defined in a generally used dictionary may be interpreted to have the meanings equal to the contextual meanings in the relevant field of art, and are not to be interpreted to have ideal or excessively formal meanings unless clearly defined in the disclosure. In some cases, even the term defined in the disclosure should not be interpreted to exclude embodiments of the disclosure.

In the following description, terms referring to signals (e.g., message, signal, signaling, sequence, and stream), terms referring to resources (e.g., symbol, slot, subframe, radio frame (RF), subcarrier, resource element (RE), resource block (RB), bandwidth part (BWP), and occasion), terms for operations (e.g., step, method, process, and procedure), terms referring to data (e.g., information, parameter, variable, value, bit, symbol, and codeword), terms referring to channels, terms referring to control information (e.g., downlink control information (DCI), medium access control codeword element (MAC CE), and radio access control (RRC) signaling), terms referring to network entities, terms referring to device elements, and the like are illustratively used for the sake of convenience. Therefore, the disclosure is not limited by the terms as described below, and other terms referring to subjects having equivalent technical meanings may be used.

Various aspects are described herein in connection with a wireless terminal and/or a base station. A wireless terminal may refer to a device providing voice and/or data connectivity to a user. The wireless terminal may be connected to a computing device such as a laptop computer or desktop computer, or it can be a self-contained device such as a personal digital assistant (PDA). A wireless terminal may also be referred to as a system, a subscriber unit, a subscriber station, a mobile station, a mobile, a mobile device, a remote station, a remote terminal, an access terminal, a user terminal, a terminal, a wireless communication device, a user agent, a user device, or user equipment. A wireless terminal may be a subscriber station, a wireless device, a cellular telephone, a PCS telephone, a cordless telephone, a session initiation protocol (SIP) phone, a wireless local loop (WLL) station, a personal digital assistant (PDA), a handheld device having wireless connection capability, or other processing 30 device connected to a wireless modem. A base station (e.g., access point) may refer to a device in an access network that communicates over the air-interface, through one or more sectors, with wireless terminals. The base station may act as a router between the wireless terminal and the rest of the access network, which can include an Internet Protocol (IP) network, by converting received air-interface frames to IP packets. The base station also coordinates management of attributes for the air interface.

A scheduler may allocate available resource blocks (RBs) existing in a downlink bandwidth of a base station to a UE at each scheduling interval, transmission time interval (TTI) t. Each scheduler used in the base station may have a different optimization objective. For example, a maximum throughput (MT) scheduler may aim to maximize spectral efficiency. (max Σ_{u∈u}Rᵤ(t)) For another example, a proportional fair (PF) scheduler may aim to maximize proportional fairness criteria.

$$( max {\sum }_{u ∈ 𝒰} \frac{{R}_{u} ( t )}{{\tilde{R}}_{u} ( t - 1 )} )$$

In the existing scheduling scheme, the base station compares per-RB metrics configured for respective schedulers and allocates an RB to a UE having the largest per-RB metric value for each RB. For example, a per-RB metric m_{u,b} (t) of an MR scheduler and a PF scheduler may be as shown in <Equation 1> below.

$${m}_{u , b} ( t ) = \{ \begin{matrix}{r}_{u , b} ( t ) & MT scheduler \\ {r}_{u , b} ( t ) / {\tilde{R}}_{u} ( t - 1 ) & PF scheduler\end{matrix} \qquad [ Equation 1 ]$$

r_{u,b} (t) may refer to an expected allocation ratio of RB b of user u at each TTI t, and Rᵤ (t-1) may refer to a long-term average data throughput of user u at TTI t-1.

The existing scheduling in a mobile network is performed at an MAC layer of the base station. A scheduler of the MAC layer of the base station may be an MT scheduler or a PF scheduler and may be optimized to efficiently allocate an RB of an available bandwidth (e.g., maximize spectral efficiency) or to ensure fairness among UEs (e.g., maximize proportional fairness criteria). However, the scheduler is not optimized to achieve a low flow completion time (FCT) of an application, and thus a scheduler which may be optimized for execution of a low-latency application is required.

Various example embodiments of the disclosure may provide a new data flow scheduling algorithm for reducing the latency of a short flow, which is sensitive to delay, at a base station in order to perform optimization of an application requiring low latency in an NR system environment.

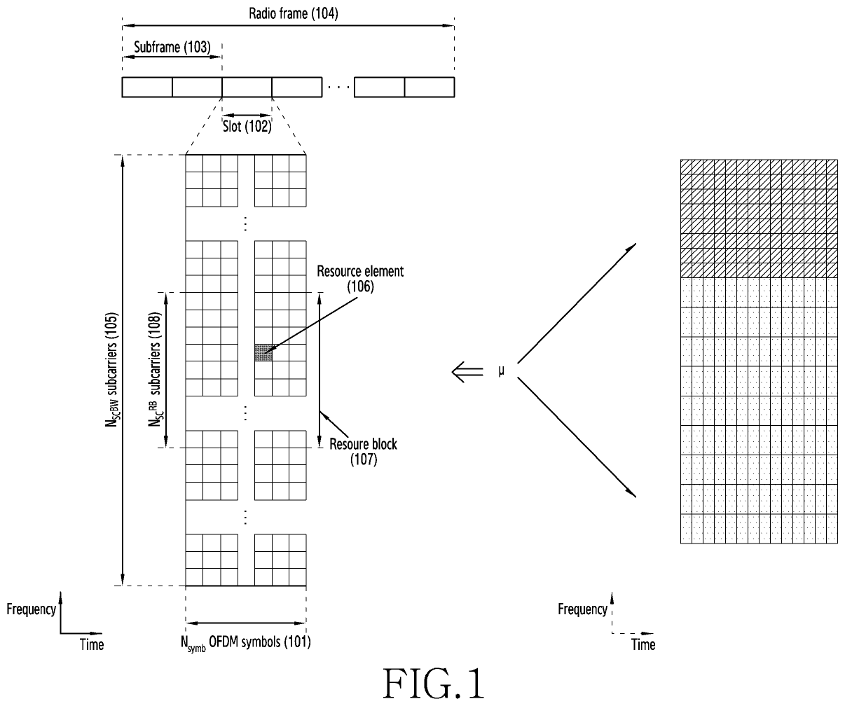

FIG. 1 is a diagram illustrating an example of a radio resource region in a wireless communication system according to various embodiments.

In various embodiments of the disclosure, a radio resource region may include a structure of a time-frequency domain. According to an embodiment, a wireless communication system may include an NR communication system.

Referring to FIG. 1, in the radio resource region, the horizontal axis indicates a time domain, and the vertical axis indicates a frequency domain. The length of a radio frame 104 is 10 ms. The radio frame 104 may be a time domain interval configured by 10 subframes. The length of a subframe 203 is 1 ms. The unit of configuration in the time domain may be an orthogonal frequency division multiplexing (OFDM) and/or a DFT-s-OFDM (discrete Fourier transform (DFT)-spread-OFDM) symbol, and Nsymb OFDM symbols and/or DFT-s-OFDM symbols 101 may be aggregated to configure one slot 102. In various embodiments, an OFDM symbol may include a symbol for a case of transmitting and receiving a signal using an OFDM multiplexing scheme, and a DFT-s-OFDM symbol may include a symbol for a case of transmitting and receiving a signal using a DFT-s-OFDM or single carrier frequency division multiple access (SC-FDMA) multiplexing scheme. The minimum transmission unit in the frequency domain is a subcarrier, and a carrier bandwidth configuring a resource grid may be configured by a total of N_{SC}^{BW} subcarriers 105. In addition, in the disclosure, an embodiment regarding downlink signal transmission and reception is described for convenience of description, but this is also applicable to an embodiment regarding uplink signal transmission and reception.

In various embodiments, the number of slots 102 configuring one subframe 103 and the length of a slot 102 may vary depending on a subcarrier spacing. Such a subcarrier spacing may be referred to as numerology (u). That is, a subcarrier spacing, the number of slots included in a subframe, the length of a slot, and the length of a subframe may be variably configured. For example, in an NR communication system, when a subcarrier spacing (SCS) is 15 kHz, one slot 102 may configure one subframe 103, and each of the lengths of the slot 102 and the subframe 103 may be 1 ms. In addition, for example, if the subcarrier spacing is 30 kHz, two slots may configure one subframe 103. In this case, the length of the slot is 0.5 ms and the length of the subframe is 1 ms.

In various embodiments, a subcarrier spacing, the number of slots included in a subframe, the length of a slot, and the length of the subframe may be variably applied depending on a communication system. For example, in the case of the LTE system, a subcarrier spacing is 15 kHz, two slots configure one subframe, and in this case, the length of a slot may be 0.5 ms and the length of the subframe may be 1 ms. For another example, in the case of the NR system, a subcarrier spacing (u) may be one of 15 kHz, 30 kHz, 60 kHz, 120 kHz, and 240 kHz, and the number of slots included in one subframe according to the subcarrier spacing (u) may be 1, 2, 4, 8, and 16.

The basic unit of a resource in the time-frequency domain may be a resource element (RE) 106, and the resource element 106 may be expressed as an OFDM symbol index and a subcarrier index. A resource block may include multiple resource elements. In the NR system, a resource block (RB) (or a physical resource block (PRB)) 107 may be defined as N_{sC}^{RB} consecutive subcarriers in the frequency domain. The number of subcarriers, N_{sC}^{RB}, may be=12. The frequency domain may include common resource blocks (CRBs). A physical resource block (PRB) may be defined in a bandwidth part (BWP) on the frequency domain. CRB and PRB numbers may be determined differently depending on a subcarrier spacing. In the LTE system, an RB may be defined as N_{SYMB} consecutive OFDM symbols in the time domain and N_{sC}^{RB} consecutive subcarriers in the frequency domain.

In the NR and/or LTE system, scheduling information for downlink data or uplink data may be transmitted from a base station to a UE via downlink control information (DCI). In various embodiments, the DCI may be defined according to various formats, and each format may indicate whether the DCI includes scheduling information (e.g., UL grant) for uplink data, whether the DCI includes scheduling information (DL resource allocation) for downlink data, whether the DCI is compact DCI having a small size of control information, whether the DCI is fallback DCI, whether spatial multiplexing using multiple antennas is applied, and/or whether the DCI is DCI for power control. For example, NR DCI format 1_0 or NR DCI format 1_1 may include scheduling for downlink data. In addition, for example, NR DCI format 0_0 or NR DCI format 0_1 may include scheduling for uplink data.

As described above, FIG. 1 illustrates an example of a downlink and uplink slot structure in a wireless communication system. For example, FIG. 1 illustrates a structure of a resource grid of a 3GPP NR system. Referring to FIG. 1, a slot may include multiple orthogonal frequency division multiplexing (OFDM) symbols in the time domain and include multiple resource blocks (RBs) in the frequency domain. A signal may be configured by a part or the entirety of the resource grid. In addition, the number of OFDM symbols included in one slot may generally vary depending on the length of a cyclic prefix (CP). In FIG. 1, for convenience of description, the case in which one slot is configured by 14 OFDM symbols is illustrated, but in the case of the signal referred to in the disclosure, the configuration of symbols is not specified. In addition, a modulation scheme of a generated signal is not limited to a specific value of quadrature amplitude modulation (QAM), and may follow modulation schemes of various communication standards such as binary phase-shift keying (BPSK) and quadrature phase shift keying (QPSK).

Although various embodiments of the disclosure are described based on the LTE communication system or the NR communication system, the content of the disclosure is not limited thereto and may be applied in various wireless communication systems for transmitting downlink or uplink control information. In addition, it is apparent that the content of the disclosure may be applied, as needed, in an unlicensed band in addition to a licensed band.

In the following description, higher layer signaling may be performed or a higher signal may be transmitted by a signal transmission method in which a base station transmits a signal to a user terminal (UE) using a downlink data channel of a physical layer, or the UE transmits a signal to the base station using an uplink data channel of the physical layer. According to an embodiment, the higher layer signaling may include at least one of radio resource control (RRC) signaling, signaling according to an F1 interface between a centralized unit (CU) and a distributed unit (DU), or a method of transmitting a signal through a media access control (MAC) control element (MAC CE). In addition, according to an embodiment, the higher layer signaling or higher signal may include system information that is commonly transmitted to multiple UEs, such as a system information block (SIB).

In a 5G wireless communication system, a synchronization signal block (SSB) (or referred to as an SS block, an SS/PBCH block, etc.) may be transmitted for initial access, and the synchronization signal block may be configured by a primary synchronization signal (PSS), a secondary synchronization, signal (SSS), and a physical broadcast channel (PBCH). In an initial access step in which a UE first accesses the system, the UE may obtain downlink time and frequency domain synchronization from a synchronization signal and obtain a cell ID, through a cell search procedure. The synchronization signal may include a PSS and an SSS. The UE may receive a PBCH including a master information block (MIB) from a base station to obtain a basic parameter value and system information related to transmission and reception, such as a system bandwidth or related control information. The UE may obtain a system information block (SIB) by performing decoding on a physical downlink control channel (PDCCH) and a physical downlink shared channel (PDSCH), based on the received PBCH. Thereafter, the UE may exchange identity with the base station through a random access step and may initially access a network through steps such as registration and authentication.

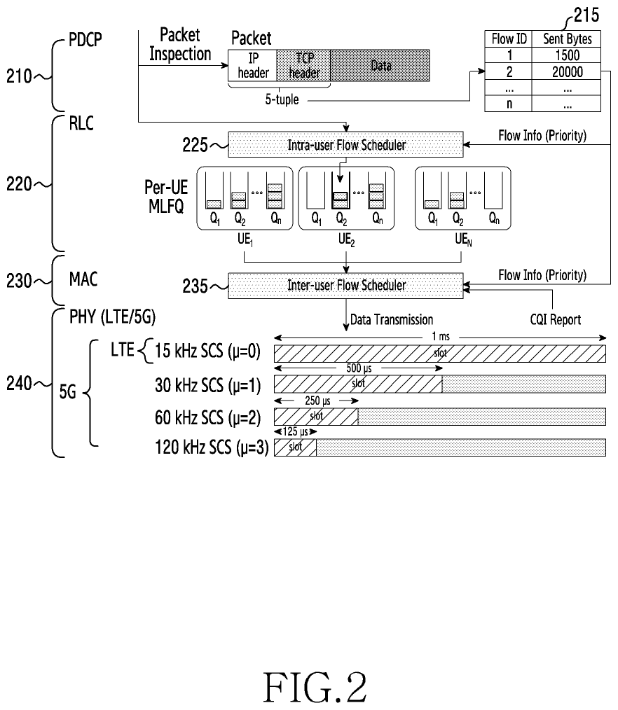

FIG. 2 is a diagram illustrating an example scheduling operation of a base station according to various embodiments.

A base station may provide an Internet connection between a user equipment (UE) and a core network (CN), and allocate radio resources available in an RAN to multiple UEs to schedule uplink and downlink traffic of a user.

Referring to FIG. 2, the base station may perform scheduling using a flow scheduler in order to improve user-perceived latency.

According to various embodiments of the disclosure, a PDCP layer 210 may have a PDCP packet which has entered the PDCP layer 210. The base station may sort a Flow ID and sent bytes of the PDCP packet. For example, when a packet arrives at a buffer of each user, the scheduler may identify a flow based on 5-tuple information (src/dst ports, src/ds tips, protocol, etc.) and sort the sent bytes so far. A “sent byte” may refer to the capacity of a flow that the base station has received from a server so far.

Priority information 215 of a data flow may be generated based on the sorted Flow ID and sent bytes. The base station may determine priorities of flows to be transmitted to one user, based on the generated priority information 215. Thereafter, information on the determined priorities and PDCP packets of the PDCP layer 210 may be transmitted to an RLC layer 220.

A conventional scheduler used in the RLC layer performs scheduling which simply allocates data to a buffer of a UE. Since a conventional scheduler of the base station allocates data to the buffer of the UE regardless of the size of the data, delay in a data flow may occur. In this case, a low-latency application sensitive to delay cannot perform an operation properly or cannot perform a specific function that requires rapid data processing.

According to various embodiments of the disclosure, in the RLC layer 220, the base station may update the priorities using an intra-user flow scheduler 225. For example, when a new flow comes in, the intra-user flow scheduler 225 may compare the size of the flow with a preconfigured threshold value to update the previously determined priorities of the flows to be transmitted to the one user.

A flow size may refer to the total capacity of the flow received at a time point when the base station updates the priorities. According to various embodiments of the disclosure, the base station may determine the flow size, based on information of the sent bytes of the flow sorted in the PDCP layer 210. For example, the base station may expect that a flow having a larger value of sent bytes has a larger flow size than a flow having a smaller value of sent bytes. For another example, in FIG. 2, when the size of sent bytes of a flow having a Flow ID of 1 is 1500 and the size of sent bytes of a flow having a Flow ID of 2 is 20000, the base station may expect that the flow having the Flow ID of 2, which has the larger size of sent bytes, has a larger flow size than the flow having the Flow ID of 1. In order to determine a flow size without prior information (e.g., QoS), the base station may determine an approximate flow size value, based on the capacity of the flow that the base station has received from the server so far. Accordingly, the base station may determine the flow size without the prior information, and the intra-user flow scheduler may compare the determined flow size with a threshold value to update the priority of a flow to be allocated to a queue.

The intra-user flow scheduler 225 may perform scheduling for a flow to a single UE. The intra-user flow scheduler 225 may perform scheduling using a multiple level feedback queue (MLFQ) scheduling scheme which may effectively approximate short remaining job first (SRJF) which first processes small-sized data.

According to various embodiments of the disclosure, the intra-user flow scheduler 225 may determine whether a flow size is smaller than a preconfigured threshold value. The threshold value may be preconfigured before the base station schedules a packet, and may be reconfigured at each predetermined interval.

When a flow size of a flow including a packet is smaller than the threshold value, the intra-user flow scheduler 225 may maintain the allocation ranking of the flow which has the priority generated by the PDCP layer 210. In the case of a flow having a flow size larger than the threshold value, the intra-user flow scheduler 225 may demote a flow allocation ranking of the flow. That is, the flow having the flow size larger than the threshold value may have its priority demoted to a lower ranking. The flow having the priority demoted to a lower ranking may have its allocation ranking demoted, and accordingly, the transmission of packets included in the flow may also be delayed. The intra-user flow scheduler 225 may compare the flow size of the flow including the packet with the threshold value to update the priority.

According to various embodiments of the disclosure, the intra-user flow scheduler 225 may allocate the packet included in the flow to a queue of the UE, based on the updated priority. The intra-user flow scheduler 225 may generate a second priority for packet data allocated to each UE, and may allocate packets to the queue of the UE, based on the second priority. Such a scheduling scheme of the intra-user flow scheduler 225 may be referred to as a multiple level feedback queue (MLFQ) scheduling scheme. For example, an algorithm of the MLFQ scheduling scheme may be expressed as <Table 1> below.

```
TABLE 1
The MLFQ scheduling includes K priority queues, Pᵢ(1≤i≤K) and K−1 thresholds,
αⱼ (1≤j≤K−1). The priorities decrease from P₁ (first priority) to P_{K} (last priority) and
MLFQ performs strict priority queueing based on the following rules:
  • The new incoming flow starts from P₁.
  • The packets corresponding to a flow having Pᵢ priority enters the Pᵢ queue.
  • A flow gets demoted from Pᵢ to Pᵢ₊₁ when sent-bytes of a flow crosses the
threshold αᵢ.
```

According to various embodiments of the disclosure, all UEs may have a separated MLFQ structure but share the same threshold value. That is, when determining whether a flow size of a flow including a packet is smaller than the threshold value, each UE may compare the same threshold value with a flow size of a flow including a packet forwarded to each UE.

According to various embodiments of the disclosure, the intra-user flow scheduler 225 employing the MLFQ scheduling scheme may minimize delay when performing a low-latency application by preferentially processing delay-sensitive data even without prior information (e.g., quality of service (QOS)).

Based on the second priority generated by the intra-user flow scheduler 225 in the RLC layer 220, packets allocated to a queue of each UE may be scheduled by a flow scheduler between users (hereinafter, an “inter-user flow scheduler”) 235 of a media access control (MAC) layer 230. The inter-user flow scheduler 235 may compare a per-RB metric of the existing scheduler of the MAC layer 230 with a per-RB metric to which a newly configured threshold value (hereinafter, a relaxation threshold) is applied, and select UEs having priorities similar to the priority of each per-RB metric. The inter-user flow scheduler 235 may not only select a UE which best satisfies the priority of each per-RB metric, but may also select multiple UEs which satisfy a range to which the newly configured threshold value is applied. The inter-user flow scheduler 235 may schedule packets between the selected UEs. The multiple UEs satisfying the range to which the newly configured threshold value is applied may have the same or similar per-RB metric values. Whether the UEs have similar per-RB metrics may be determined based on whether the characteristics of the UEs exceed a value of preconfigured similarity related to the per-RB metrics.

According to various embodiments of the disclosure, the packets scheduled by the inter-user flow scheduler 235 of the MAC layer 230 may be transmitted to a PHY layer 240.

The PHY layer 240 may handle the packets received from the MAC layer 230 and may provide a communication interface between higher layers of a modem stack and hardware supporting physical transmission mediums (e.g., transceivers, antennas, etc.). The PHY layer 240 may convert the packets into bitstreams for transmission and/or convert the received bitstreams into PHY packets. In addition, the PHY layer 240 may provide encoding, transmission, reception, and/or decoding for packets.

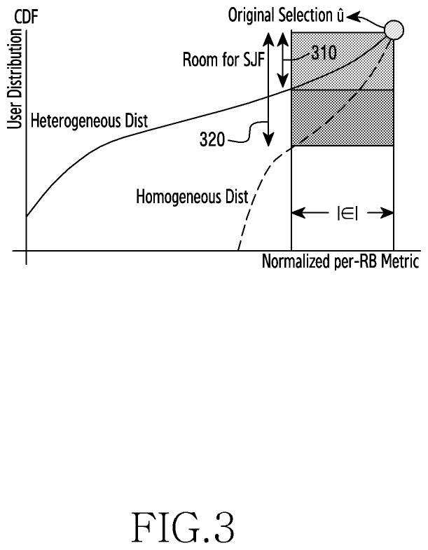

FIG. 3 is a graph illustrating example user distribution versus a normalized per-RB metric according to various embodiments. For example, FIG. 3 illustrates a user selection operation of an inter-user flow scheduler (e.g., 235 in FIG. 2).

An inter-user flow scheduler may select UEs by applying relaxation threshold & to a per-RB metric used by the existing scheduler of the MAC layer 230. For example, the inter-user flow scheduler may select a UE having a smaller flow size by securing, as much as |ε|, a space for scheduling of a flow including a packet, and preserving a per-RB metric of the existing scheduler as much as 1-|ε|. When a user selected by the existing scheduler is referred to as û=argmax_{u∈u}m_{u,b}, the inter-user flow scheduler may select a new set u′ from which new users are selected. The equation regarding the user selected by the existing scheduler and the new users selected by the inter-user flow scheduler may be expressed as <equation 2>.

$$\hat{u} = arg {max}_{u ∈ {𝒰}^{′}} ( {max}_{f ∈ {ℱ}_{u}} Priority ( f ) ) \qquad [ Equation 2 ]$$

$$where , {𝒰}^{′} = \{ {u}^{′} \vert ( 1 - ε ) \cdot {m}_{\hat{u} , b} \leq {m}_{{u}^{′} , b} , {u}^{′} ∈ 𝒰 \}$$

Referring to FIG. 3, the existing scheduler may select a user û who best matches a per-RB metric configured by the scheduler in each transmission time interval (TTI) which refers to an interval of scheduling. The inter-user flow scheduler may secure, as much as |ε|, a space for scheduling of a data flow and may select UEs belonging to the space of |ε|. In this case, the size of a space (room) which refers to a set of UEs having the same or similar per-RB metrics may be changed depending on a user distribution pattern. For example, the size of a first space 320, which is a space in the case where users show a homogeneous per-RB distribution, may be compressed to the size of a second space 310, which is a space in the case where the users show a heterogeneous per-RB distribution. In this case, a corresponding space may also be referred to as a shortest job first (SJF) space.

Whether the UEs have similar per-RB metrics may be determined based on whether the characteristics of the UEs exceed a value of preconfigured similarity related to the per-RB metrics.

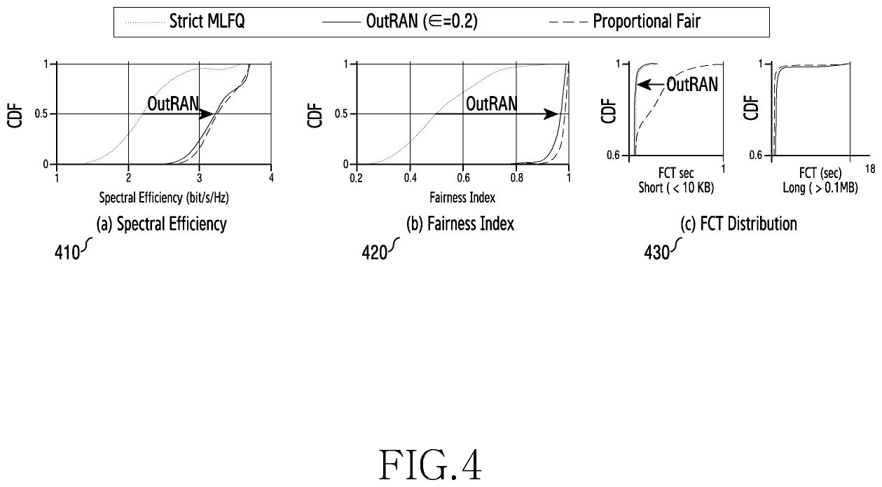

According to various embodiments of the disclosure, a base station may preconfigure a value of ε, and may also be adjusted through feedback during a scheduling process. FIG. 4 is a graph comparing CDF results with other schedulers when a value of relaxation threshold ε is 0.2.

FIG. 4 is a graph illustrating cumulative density function (hereinafter, CDF) results of spectral efficiency, fairness index, and FCT distribution of schedulers according to various embodiments, for example, OutRAN represents a case where an inter-user flow scheduler configures relaxation threshold ε to ε=0.2, and strict MLFQ represents a case where a separate ε value is not configured. When the inter-user flow scheduler configures relaxation threshold ε to ε=0.2, the size of an SJF space may be changed.

A graph 410 showing a CDF result versus spectral efficiency shows a CDF result of a spectral efficiency value when a TTI is 50. The spectral efficiency may refer to transmission/reception frequency efficiency or transmission efficiency per bandwidth. An OutRAN-based scheduler may achieve almost the same spectral efficiency when compared to a proportional fair (PF) scheduler.

A graph 420 showing a CDF result versus a fairness index shows a CDF result of a fairness index value when a TTI is 50. The fairness index may be an indicator indicating the fairness of radio resource allocation. The OutRAN-based scheduling may show almost the same fairness when compared to the PF scheduler.

A graph 430 showing a CDF result versus FCT distribution shows a CDF result when a FCT time is short (for example, when a FCT time is less than 10 KB) and when the FCT time is long (for example, when the FCT time exceeds 0.1 MB). The OutRAN may effectively minimize a short flow FCT compared to the PF scheduler. In addition, the OutRAN may achieve a similar result to the PF scheduler without depleting a long flow.

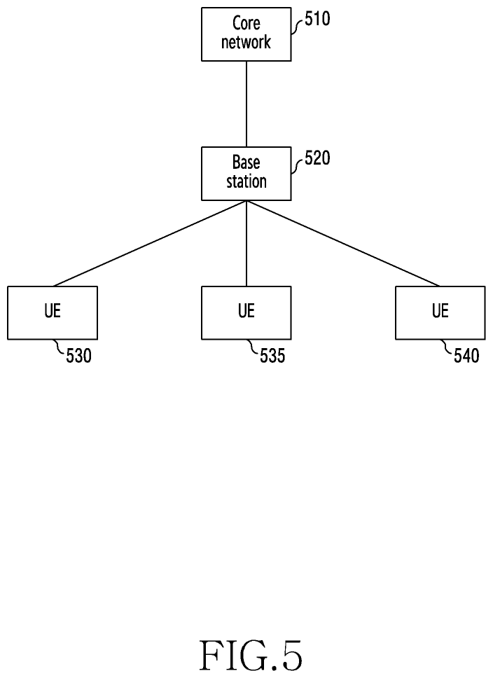

FIG. 5 is a block diagram illustrating an example network structure in a wireless communication system according to various embodiments. For example, FIG. 5 shows a network structure including a base station and a UE to which the scheduling algorithm of FIG. 2 is applied.

Referring to FIG. 5, a wireless communication system may include multiple UEs 530, 535, and 540 and a base station 520. The base station 520 may be connected to a core network 510 through a wired network, and may transmit or receive data to or from the multiple UEs 530, 535, and 540 through a wireless channel environment. The multiple UEs 530, 535, and 540 may include not only those illustrated in FIG. 5, but also UE 1, UE 2, . . . , UE N (N is a positive integer).

The base station 520 may include a scheduling device including a scheduler. The scheduling device of the base station 520 may perform scheduling for a downlink channel, based on scheduling information provided from the scheduler to the UEs. The scheduling information may include a per-RB metric value calculated based on channel information of each UE.

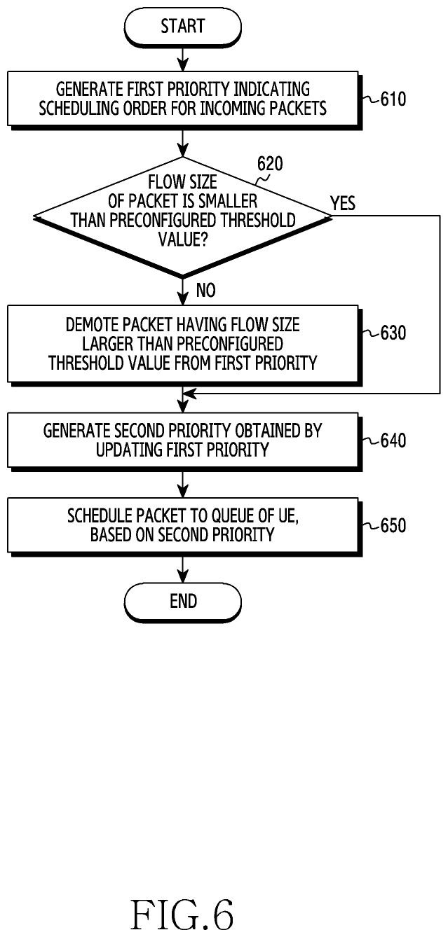

FIG. 6 is a flowchart illustrating an example operation of a base station according to various embodiments. For example, FIG. 6 illustrates an example operation of an intra-user flow scheduler within a base station.

Referring to FIG. 6, in operation 610, a base station may generate a priority indicating a scheduling order for incoming packets. For example, the base station may generate a priority indicating an allocation ranking to a queue for a flow including the incoming packets. For example, in FIG. 2, the PDCP layer 210 may have a PDCP packet which has entered the PDCP layer 210. The base station may sort a Flow ID and sent bytes of the PDCP packet. The base station may generate a flow priority indicating the allocation ranking of the flow, based on the sorted Flow ID and sent bytes. The priority may be referred to as, for example, a first priority.

In operation 620, when a new flow comes in, the base station may compare the size of the flow with a preconfigured (e.g., specified) threshold value through an intra-user flow scheduler existing within the base station, and thus update the priority. For example, the base station may determine whether the size of the flow is smaller than the preconfigured threshold value through the intra-user flow scheduler, maintain the allocation ranking of the flow having the priority when the size of the flow is smaller than the threshold value, and update the allocation ranking of the flow having the priority to a lower ranking when the size of the flow is larger than the threshold value. The intra-user flow scheduler may intend to schedule a data flow having a flow size smaller than the preconfigured threshold value. When the flow size of the flow including a packet is larger than the preconfigured threshold value, the process may move to operation 630, and when the flow size of the flow including the packet is smaller than the threshold value, the process may move between operations 630 and 640.

In operation 630, when the flow size of the flow including the packet is larger than the preconfigured threshold value, the base station may demote a flow allocation ranking in the priority for the flow to a lower ranking. As a result, the intra-flow scheduler may allocate a flow having a small flow size to the queue with the highest priority.

In operation 640, the base station may generate the priority updated in operation 630. The updated priority may refer to a priority including the allocation ranking of the flow having the priority demoted since the flow size of the flow is larger than the threshold value in the previously determined priority. For example, in FIG. 2, the intra-user flow scheduler 225 may maintain the allocation ranking of the flow having the priority determined in the PDCP layer 210 when the flow size of the flow including the packet is smaller than the threshold value. The intra-user flow scheduler 225 may demote the allocation ranking of the flow having the priority determined in the PDCP layer 210 when the flow size of the flow is larger than the threshold value.

For example, the intra-user flow scheduler 225 may compare the flow size of the flow including the packet with the threshold value to update the priority. The updated priority may be referred to as, for example, a second priority.

In operation 650, the intra-user flow scheduler of the base station may allocate packets to a queue of a UE, based on the updated priority. For example, the intra-user flow scheduler may determine a priority for allocating packets allocated to each UE to the queue, and may allocate packets to the queue of the UE, based on the updated priority. Such a scheduling scheme of the intra-user flow scheduler may be referred to as a multiple level feedback queue (MLFQ) scheduling scheme.

According to various embodiments of the disclosure, all UEs may have a separated MLFQ structure but share the same threshold value. That is, when determining whether a flow size of a flow including a packet is smaller than a threshold value, each UE may compare the same threshold value with a flow size of a flow including packets allocated to each UE.

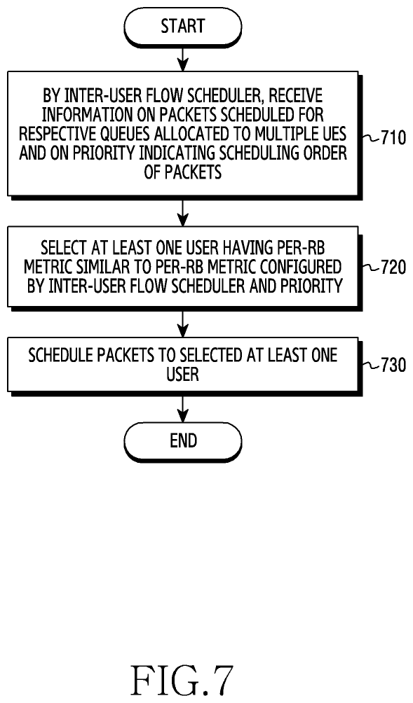

FIG. 7 is a flowchart illustrating an example operation of a base station according to various embodiments. For example, FIG. 7 illustrates an example operation of an inter-user flow scheduler within a base station.

Referring to FIG. 7, in operation 710, an inter-user flow scheduler (hereinafter, an “inter-user flow scheduler”) within a base station may receive information on packets scheduled for respective queues allocated to multiple UEs and on a priority indicating a scheduling order of the packets. In this case, the received information on the priority may include information on a priority received from the inter-user flow scheduler. For example, the received information on the priority may be information on a priority of a flow including packets allocated to a queue of a UE generated by the inter-user flow scheduler.

In operation 720, the inter-user flow scheduler may select at least one user having a per-RB metric similar to a per-RB metric configured by the inter-user flow scheduler and the received priority. Whether the UEs have similar per-RB metrics may be determined based on whether the characteristics of the UEs exceed a value of preconfigured similarity related to the per-RB metrics. The inter-user flow scheduler may compare a per-RB metric of the existing scheduler of an MAC layer (e.g., 230 in FIG. 2) with a per-RB metric to which a newly configured threshold value (hereinafter, a relaxation threshold) is applied, as shown in FIG. 2, and select UEs having priorities similar to the priority of each per-RB metric. The inter-user flow scheduler may not only select a UE which best satisfies the priority of each per-RB metric, but may also select multiple UEs which satisfy a range to which the newly configured threshold value is applied.

According to various embodiments of the disclosure, the per-RB metric may be a variable configured by the scheduler. Therefore, a per-RB metric regarding a priority for scheduling packets may be different for each scheduler. In an example, the per-RB metric may be one of channel quality and quality of service (QOS).

In operation 730, the base station may allocate the packets to the selected at least one user.

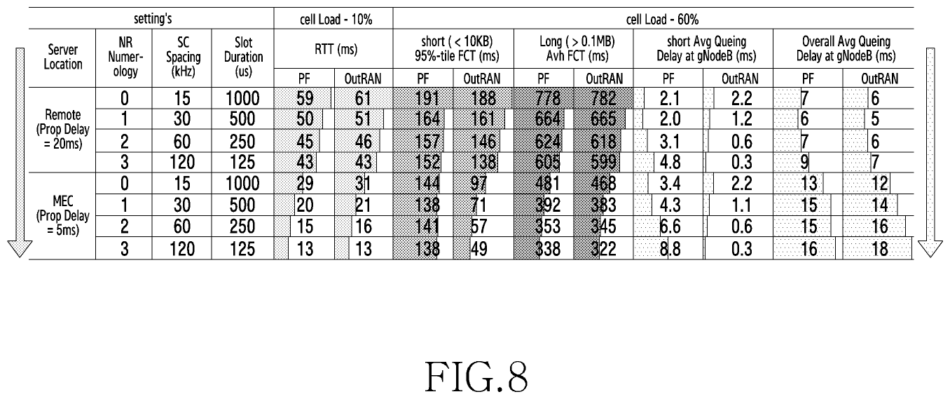

FIG. 8 is a table illustrating a result of an example scheduling operation of a base station according to various embodiments. For example, FIG. 8 illustrates a simulation result of radio resource allocation according to intra-user flow scheduler and inter-user flow scheduler operations of a base station in an NR system. OutRAN in FIG. 8 may refer to a case where data is scheduled using an intra-user flow scheduler and an inter-user flow scheduler, and a PF may refer to the amount of data delay when data is scheduled using a conventional PF scheduler.

When the load of a cell is 10% and moderate traffic congestion occurs in the cell, an RTT may show a significant decrease as a server location gets closer to a base station. However, when the load of the cell increases to 60%, queue accumulation delay at the base station occurs, which may worsen the overall queue accumulation at the base station. (for example, Overall Avg Queuing Delay at gNodeB in FIG. 8) In addition, a short data flow may experience severe queuing delay. (for example, short Ang Queuing Delay at gNodeB in FIG. 8)

According to various embodiments of the disclosure, when packets of a flow having a flow size smaller than a threshold value are prioritized and allocated, the delay of data can be reduced when performing an operation of a low-latency application sensitive to delay. In FIG. 8, when the load of the cell increases to 60%, it may be identified that a delay rate of data scheduled through an OutRAN scheduler is significantly lower than that of data scheduled by a PF scheduler in the case of a short data flow.

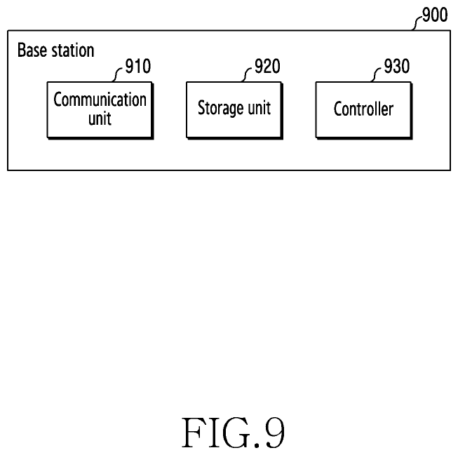

FIG. 9 is a block diagram illustrating an example configuration of a base station according to various embodiments.

Referring to FIG. 9, a base station 900 includes a communication unit 910, a storage 920, and a controller 930.

The communication unit 910 performs functions for transmitting/receiving signals through a radio channel. For example, the communication unit 910 performs functions of conversion between baseband signals and bitstrings according to the physical layer specifications of the system. For example, during data transmission, the communication unit 910 generates complex symbols by encoding and modulating a transmission bitstream. In addition, during data reception, the communication unit 910 demodulates and decodes a baseband signal to restore a received bitstring. In addition, the wireless communication unit 910 up-converts a baseband signal to a radio frequency (RF) band signal, transmits the up-converted RF band signal via an antenna, and then down-converts the RF band signal received via the antenna to a baseband signal.

To this end, the wireless communication unit 910 may include a transmission filter, a reception filter, an amplifier, a mixer, an oscillator, a digital to analog converter (DAC), an analog to digital converter (ADC), and the like. In addition, the communication unit 910 may include multiple transmission/reception paths. Furthermore, the wireless communication unit 910 may include at least one antenna array including multiple antenna elements. In terms of hardware, the wireless communication unit 910 may include a digital unit and an analog unit, and the analog unit may include multiple sub-units according to operation power, frequencies, etc.

The communication unit 910 may transmit/receive signals. To this end, the communication unit 910 may include at least one transceiver. For example, the communication unit 910 may transmit a synchronization signal, a reference signal, system information, a message, control information, data, or the like. Furthermore, the communication unit 910 may perform beamforming.

The communication unit 910 transmits and receives signals as described above. Accordingly, all or part of the communication unit 910 may be referred to as a “transmitter”, a “receiver”, or a “transceiver”. In addition, as used in the following description, the meaning of “transmission and reception performed through a radio channel” includes the meaning that the above-described processing is performed by the communication unit 910.

The storage 920 stores data such as basic programs, application programs, and configuration information for operations of the base station. The storage 920 may include a memory. The storage 920 may include a volatile memory, a nonvolatile memory, or a combination of a volatile memory and a nonvolatile memory. In addition, the storage 920 provides the stored data at the request of the controller 930.

The controller 930 controls the overall operation of the base station 900 according to a scheduling method of a scheduler included in the base station 900 and an apparatus therefor.

For example, the controller 930 transmits/receives signals through the communication unit 910. In addition, the controller 930 records data in the storage 920 and reads the data from the storage 920. Furthermore, the controller 930 may perform functions of protocol stacks required by communication specifications. To this end, the controller 930 may include at least one processor. To this end, at least one processor may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The structure of the base station 900 illustrated in FIG. 9 is a merely an example of the base station, and examples of the base station for performing various embodiment of the disclosure are not limited to the structure illustrated in FIG. 9. For example, some elements may be added, omitted, or changed according to various embodiments.

In FIG. 9, the base station 900 has been described as a single entity, but the disclosure is not limited thereto. In addition to the integrated deployment, the base station 900 according to various embodiments of the disclosure may be implemented to construct an access network having a distributed deployment. According to an embodiment, the base station may be divided into a central unit (CU) and a digital unit (DU), the CU may be implemented to perform upper layer functions (e.g., packet data convergence protocol (PDCP) and RRC), and the DU may be implemented to perform lower layer functions (e.g., medium access control (MAC) and physical (PHY)). The DU of the base station may form beam coverage on a radio channel.

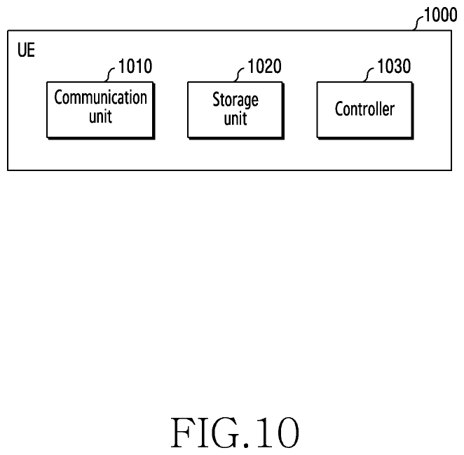

FIG. 10 is a block diagram illustrating an example configuration of a UE according to various embodiments.

FIG. 10 illustrates an example configuration of a UE 1000 in the wireless communication system according to various embodiments.

The configuration illustrated in FIG. 10 may be understood as a configuration of the UE 1000. The terms “ . . . unit”, “ . . . device”, etc. used hereinafter refer to a unit configured to process at least one function or operation, and may be implemented as hardware, software, or a combination of hardware and software.

Referring to FIG. 10, the UE 1000 includes a communication unit (e.g., including communication circuitry) 1010, a storage unit (e.g., a memory) 1020, and a controller (e.g., including processing circuitry) 1030.

The communication unit 1010 may include various communication circuitry and performs functions for transmitting/receiving signals through a radio channel. For example, the communication unit 1010 performs functions of conversion between baseband signals and bitstrings according to the physical layer specifications of the system. For example, in case of data transmission, the communication unit 1010 generates complex symbols by encoding and modulating a transmission bitstream. In addition, in case of data reception, the communication unit 1010 demodulates and decodes a baseband signal to restore a received bitstring. In addition, the communication unit 1010 up-converts a baseband signal to an RF band signal, transmits the same through an antenna, and down-converts an RF band signal received through the antenna to a baseband signal. For example, the communication unit 1010 may include a transmission filter, a reception filter, an amplifier, a mixer, an oscillator, a DAC, and an ADC.

In addition, the communication unit 1010 may include multiple transmission/reception paths. Furthermore, the communication unit 1010 may include an antenna unit. The communication unit 1010 may include at least one antenna array configured by multiple antenna elements. In terms of hardware, the communication unit 1010 may include a digital circuit and an analog circuit (e.g., a radio frequency integrated circuit (RFIC)). The digital circuit and the analog circuit may be implemented as a single package. In addition, the communication unit 1010 may include multiple RF chains.

In addition, the communication unit 1010 may transmit/receive signals. To this end, the communication unit 1010 may include at least one transceiver. In addition, the communication unit 1010 may receive an uplink signal. The downlink signal may include a synchronization signal (SS), a reference signal (RS) (e.g., cell-specific reference signal (CRS)), a demodulation (DM)-RS, system information (e.g., MIB, SIB, remaining system information (RMSI), and other system information (OSI)), a configuration message, control information, downlink data, or the like. The communication unit 1010 may transmit a downlink signal. The uplink signal may include a random access-related signal (e.g., a random-access preamble (RAP) (or message 1 (Msg1) and message 3 (Msg3)), a reference signal (e.g., a sounding reference signal (SRS) and a DM-RS), a power headroom report (PHR), or the like.

In addition, the communication unit 1010 may include different communication modules for processing signals in different frequency bands. Furthermore, the communication unit 1010 may include multiple communication modules in order to support multiple different radio access techniques. For example, different radio access technologies may include Bluetooth low energy (BLE), wireless fidelity (Wi-Fi), Wi-Fi gigabyte (WiGig), cellular networks (e.g., long-term evolution (LTE)), new radio (NR), and the like. In addition, different frequency bands may include super high frequency (SHF) (e.g., 2.5 Ghz and 5 Ghz) bands and millimeter (mm) wave (e.g., 38 GHz, 60 GHz, etc.) bands. In addition, the communication unit 1010 may also use the same type radio access technique in different frequency bands (e.g., unlicensed bands for licensed assisted access (LAA) or citizens broadband radio service (e.g., 3.5 GHz)).

The communication unit 1010 transmits and/or receives signals as described above. Accordingly, all or part of the communication unit 1010 may be referred to as a “transmitter”, a “receiver”, or a “transceiver”. In addition, as used in the following description, the meaning of “transmission and reception performed through a radio channel” includes the meaning that the above-described processing is performed by the communication unit 1010.

The storage unit 1020 may include a memory and stores data, such as a basic program, an application program, and configuration information for operations of the UE 1000. The storage 1020 may include a volatile memory, a nonvolatile memory, or a combination of a volatile memory and a nonvolatile memory. In addition, the storage 1020 provides the stored data at the request of the controller 1030.

The controller 1030 may include various processing circuitry and controls overall operations of the UE 1000. For example, the controller 1030 transmits/receives signals through the communication unit 1010. In addition, the controller 1030 records data in the storage 1020 and reads the data from the storage 1020. In addition, the controller 1030 may perform functions of protocol stacks required by communication specifications. To this end, the controller 1030 may include at least one processor. The controller 1030 may include at least one processor or micro-processor, or may be a part of a processor. Thus, the controller may include a processor including various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. In addition, a part of the communication unit 1010 and the controller 1030 may be referred to as a communication processor (CP). The controller 1030 may include various modules for performing communication. According to various embodiments, the controller 1030 may control the UE to perform operations according to various embodiments.

The various example embodiments of the disclosure are merely examples that have been presented to easily explain the technical contents of embodiments of the disclosure and help understanding the disclosure, and are not intended to limit the scope of the disclosure. It will be apparent to one skilled in the art that other variants based on the technical idea of the disclosure may be implemented. Also, the above respective embodiments may be employed in combination, as necessary.

As described above, according to various example embodiments of the disclosure, a method performed by a base station in a wireless communication system may include: determining priorities of flows to be transmitted to one user, when a new flow comes in, determining whether a size of the flow is smaller than a preconfigured threshold value and updating the priorities, by an intra-user flow scheduler, and allocating the flow to a queue, based on the updated priorities.

According to various example embodiments of the disclosure, the updating of the priorities may include maintaining an allocation ranking of the flow having a determined priority when the size of the flow is smaller than the preconfigured threshold value, and updating the allocation ranking of the flow having the priority to a lower ranking when the size of the flow is larger than the preconfigured threshold value.

According to various example embodiments of the disclosure, the method may employ a multiple level feedback queue (MLFQ) scheduling scheme in which packets are allocated to a queue of a UE.

According to various example embodiments of the disclosure, the priorities may be determined according to a preconfigured period.

According to various example embodiments of the disclosure, the method may be performed at a radio link control (RLC) layer.

As described above, according to various example embodiments of the disclosure, a device of a base station in a wireless communication system may include: a transceiver and at least one processor, wherein the at least one processor is configured to determine priorities of flows to be transmitted to one user, when a new flow comes in, determine whether a size of the flow is smaller than a preconfigured threshold value and update the priorities, by an intra-user flow scheduler, and allocate the flow to a queue, based on the updated priorities.

According to various example embodiments of the disclosure, at least one processor, individually and/or collectively, may be configured to cause the device to: maintain an allocation ranking of the flow having a determined priority based on the size of the flow being smaller than the specified threshold value, and update the allocation ranking of the flow having the priority to a lower ranking based on the size of the flow being larger than the preconfigured threshold value.

According to various example embodiments of the disclosure, at least one processor, individually and/or collectively, may be configured to cause the device to: perform a multiple level feedback queue (MLFQ) scheduling scheme in which packets are allocated to the queue.

According to various example embodiments of the disclosure, the priorities may be determined according to a preconfigured period.

According to various example embodiments of the disclosure, at least one processor, individually and/or collectively, may be configured to cause the device to: operate at a radio link control (RLC) layer.

According to various example embodiments of the disclosure, at least one processor, individually and/or collectively, may be configured to cause the device to: maintain the first priority for a packet, which has a flow size smaller than the preconfigured threshold value, among packets belonging to the first priority.

As described above, according to various example embodiments of the disclosure, a method performed by a base station in a wireless communication system may include: receiving, by an inter-user flow scheduler, information on packets scheduled for respective queues allocated to multiple UEs and on a priority indicating a scheduling order of the packets, selecting at least one user having a per-resource block (RB) metric similar to a per-RB metric configured by the inter-user flow scheduler and the priority, and allocating the packets to the selected at least one user.

According to various example embodiments of the disclosure, the per-RB metric may be a variable defined by the scheduler.

According to various example embodiments of the disclosure, the per-RB metric may be one of channel quality and quality of service (QOS).

According to various example embodiments of the disclosure, the method may be performed at a media access control (MAC) layer.

According to various example embodiments of the disclosure, the received information on the priority may include information on a priority received from an intra-user flow scheduler.

As described above, according to various example embodiments of the disclosure, a device of a base station in a wireless communication system may include: a transceiver and at least one processor, comprising processing circuitry, wherein at least one processor, individually and/or collectively, is configured to cause the device to: receive, by an inter-user flow scheduler, information on packets scheduled for respective queues allocated to multiple UEs and on a priority indicating a scheduling order of the packets, select at least one user having a per-resource block (RB) metric similar to a per-RB metric configured by the inter-user flow scheduler and the priority, and allocate the packets to the selected at least one user.

According to various example embodiments of the disclosure, the per-RB metric may be a variable defined by the scheduler.

According to various example embodiments of the disclosure, the per-RB metric may be one of channel quality and quality of service (QOS).

According to various example embodiments of the disclosure, at least one processor, individually and/or collectively, may be configured to cause the device to operate at a media access control (MAC) layer.

According to various example embodiments of the disclosure, the received information on the priority may include information on a priority received from an intra-user flow scheduler.

While the disclosure has been illustrated and described with reference to various example embodiments, it will be understood that the various example embodiments are intended to be illustrative, not limiting. It will be further understood by those skilled in the art that various modifications, variations and alternatives may be made without departing from the true sprit and full scope of the disclosure, including the appended claims and their equivalents. It will also be understood that any of the embodiment(s) described herein may be used in conjunction with any other embodiment(s) described herein.

What is claimed is:

1. A method performed by a base station in a wireless communication system, the method comprising:
determining priorities of flows to be transmitted to a user;
in case that a new flow comes in, determining, by an intra-user flow scheduler, whether a size of the flow is smaller than a preconfigured threshold value, and updating the priorities; and
allocating the flow to a queue, based on the updated priorities.

2. The method of claim 1, wherein the updating of the priorities further comprises: maintaining an allocation ranking of the flow according to the priorities in case that the size of the flow is smaller than the preconfigured threshold value, and updating the allocation ranking of the flow according to the priorities to a lower ranking in case that the size of the flow is larger than the preconfigured threshold value.

3. The method of claim 1, wherein the method employs a multiple level feedback queue (MLFQ) scheduling scheme in which packets are allocated to the queue.

4. The method of claim 1, wherein the priorities are determined according to a preconfigured period, and
the method is performed at a radio link control (RLC) layer.

5. A device of a base station in a wireless communication system, the device comprising:
a transceiver; and
at least one processor,
wherein the at least one processor is configured to:
determine priorities of flows to be transmitted to a user;
in case that a new flow comes in, determine, by an intra-user flow scheduler, whether a size of the flow is smaller than a preconfigured threshold value, and update the priorities; and
allocate the flow to a queue, based on the updated priorities.

6. The device of claim 5, wherein the at least one processor is configured to maintain an allocation ranking of the flow according to the priorities in case that the size of the flow is smaller than the preconfigured threshold value, and update the allocation ranking of the flow according to the priorities to a lower ranking in case that the size of the flow is larger than the preconfigured threshold value.

7. The device of claim 5, wherein the at least one processor is configured to perform a multiple level feedback queue (MLFQ) scheduling scheme in which packets are allocated to the queue.

8. The device of claim 5, wherein the priorities are determined according to a preconfigured period, and
the at least one processor is configured to operate at a radio link control (RLC) layer.

9. A method performed by a base station in a wireless communication system, the method comprising:
receiving, by an inter-user flow scheduler, information on packets scheduled in respective queues allocated to multiple terminals and on a priority indicating a scheduling order of the packets;
selecting at least one user having a per-resource block (RB) metric similar to a per-RB metric configured by the inter-user flow scheduler and the priority; and
allocating the packets to the selected at least one user.

10. The method of claim 9, wherein the per-RB metric is a variable defined by the scheduler, and includes one of channel quality and quality of service (QOS).

11. The method of claim 9, wherein the method is performed at a media access control (MAC) layer.

12. The method of claim 9, wherein the received information on the priority comprises information on a priority received from an intra-user flow scheduler.

13. A device of a base station in a wireless communication system, the device comprising:
a transceiver; and
at least one processor,
wherein the at least one processor is configured to:
receive, by an inter-user flow scheduler, information on packets scheduled in respective queues allocated to multiple terminals and on a priority indicating a scheduling order of the packets;
select at least one user having a per-resource block (RB) metric similar to a per-RB metric configured by the inter-user flow scheduler and the priority; and
allocate the packets to the selected at least one user.

14. The device of claim 13, wherein the per-RB metric is a variable defined by the scheduler, and includes one of channel quality and quality of service (QOS).

15. The device of claim 13, wherein the at least one processor is configured to operate at a media access control (MAC) layer.

16. The device of claim 13, wherein the received information on the priority comprises information on a priority received from an intra-user flow scheduler.
